(19) United States
(12) Patent Application Publication
(10) Pub. No.: US 2024/0324066 A1
(43) Pub. Date: Sep. 26, 2024

(54) COMMUNICATION SYSTEM, COMMUNICATION CONTROL METHOD, AND BASE STATION

(71) Applicant: SHARP KABUSHIKI KAISHA, Sakai City, Osaka (JP)

(72) Inventors: MAKOTO YAMAMOTO, Sakai City, Osaka (JP); KATSUTOSHI Ishikura, Sakai City, Osaka (JP); ATSUSHI YAMAZAKI, Sakai City, Osaka (JP); HIDEAKI SHINMEI, Sakai City, Osaka (JP); Atsuko KUNISADA, Sakai City, Osaka (JP); RYOKI HINATA, Sakai City, Osaka (JP)

(21) Appl. No.: 18/575,696

(22) PCT Filed: Feb. 16, 2022
(86) PCT No.: PCT/JP2022/006030

§ 371 Date: Dec. 29, 2023

(30) Foreign Application Priority Data
Jul. 13, 2021 (JP) 2021-115397

(51) Int. Cl. H04W 76/30; H04W 84/20; H04W 88/04

(52) U.S. Cl. CPC H04W 76/30; H04W 84/20; H04W 88/04

(57) ABSTRACT

The disclosure provides a communication system, a communication control method, and a base station capable of improving security in communication using a tethering function. The communication system includes: a base station; a terminal apparatus capable of performing data communication with the base station, the terminal apparatus including a tethering function of operating as a master terminal apparatus communicatively connecting a slave terminal apparatus to the base station; and the slave terminal apparatus capable of utilizing the communicative connection using the tethering function of the terminal apparatus, in which at least the communicative connection between the slave terminal apparatus and the base station is stopped, in a case that the communicative connection by the slave terminal apparatus to the base station is not allowed.

### TECHNICAL FIELD

The present invention relates to a communication system, a communication control method, and a base station. This application claims priority based on JP 2021-115397 filed on Jul. 13, 2021, the contents of which are incorporated herein by reference.

### BACKGROUND ART

Conventionally, a system is known that performs information communication using a tethering function. For example, PTL 1 discloses a system in which a second communication apparatus is communicatively connected to a communication network via a first communication apparatus.

### CITATION LIST

### Patent Literature

PTL 1: JP 6477223 B

### SUMMARY OF INVENTION

### Technical Problem

In communication using a tethering function, a slave terminal apparatus can communicate with a base station via a master terminal apparatus, the slave terminal apparatus using a tethering function to communicatively connect to the master terminal apparatus performing data communication with the base station. However, in a case that, for example, a communication network provided by the base station is to be provided only to a specific user, there is a security risk of a third party other than the specific user possibly connecting to the communication network through the tethering function. For example, communication can be performed between a slave terminal apparatus for which a communicative connection to the communication network is not allowed and the base station, due to the third party connecting, through a tethering function, the slave terminal apparatus for which the communicative connection to the communication network is not allowed to a master terminal apparatus for which the communicative connection with the communication network is allowed.

The disclosure has been made in view of the above-described problem. An object of the disclosure is to provide a communication system, a communication control method, and a base station capable of improving security in communication using a tethering function.

### Solution to Problem

A communication system according to an aspect of the disclosure includes: a base station; a terminal apparatus capable of performing data communication with the base station, the terminal apparatus including a tethering function of operating as a master terminal apparatus communicatively connecting a slave terminal apparatus to the base station; and the slave terminal apparatus capable of utilizing the communicative connection using the tethering function of the terminal apparatus, in which at least the communicative connection between the slave terminal apparatus and the base station is stopped, in a case that the communicative connection by the slave terminal apparatus to the base station is not allowed.

A communication control method according to an aspect of the disclosure is performed by a communication system, the communication system including: a base station; a terminal apparatus capable of performing data communication with the base station, the terminal apparatus including a tethering function of operating as a master terminal apparatus communicatively connecting a slave terminal apparatus to the base station; and the slave terminal apparatus capable of utilizing the communicative connection using the tethering function of the terminal apparatus. The communication control method includes stopping, by the base station or the terminal apparatus, at least the communicative connection between the slave terminal apparatus and the base station, in a case that the communicative connection by the slave terminal apparatus to the base station is not allowed.

A base station according to an aspect of the disclosure includes: a communicator transmitting and/or receiving a radio signal used for data communication with a terminal apparatus; and a controller, in which the terminal apparatus includes a tethering function of operating as a master terminal apparatus communicatively connecting a slave terminal apparatus to the base station, and the controller: determines whether the communicative connection by the slave terminal apparatus to the base station is allowed in a case of attempting to establish the communicative connection between the slave terminal apparatus and the base station via the terminal apparatus using the tethering function; and performs control to stop at least the communicative connection between the slave terminal apparatus and the base station in the case that the communicative connection by the slave terminal apparatus to the base station is not allowed.

### BRIEF DESCRIPTION OF DRAWINGS

FIG. 1 is a diagram illustrating a schematic configuration of a communication system according to an embodiment.

FIG. 2 is a function block diagram illustrating an example of configuration of the communication system of FIG. 1.

FIG. 3 is a sequence diagram illustrating a first example of processing by the communication system of FIG. 2.

FIG. 4 is a sequence diagram illustrating a second example of the processing by the communication system of FIG. 2.

FIG. 5 is a sequence diagram illustrating a third example of the processing by the communication system of FIG. 2.

FIG. 6 is a flowchart illustrating an example of processing performed by a base station of FIG. 2.

### DESCRIPTION OF EMBODIMENTS

Embodiments of the disclosure will be described below with reference to the drawings. Note that in the drawings, the same or equivalent components are denoted by the same reference numerals and duplicate description of the same or equivalent components will be omitted.

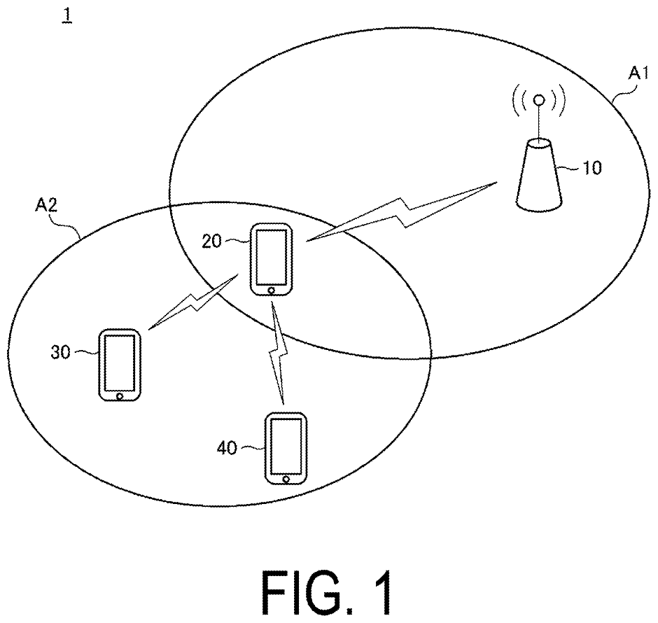

FIG. 1 is a diagram illustrating a schematic configuration of a communication system 1 according to an embodiment. As illustrated in FIG. 1, the communication system 1 includes a base station 10, a terminal apparatus 20, a first slave terminal apparatus 30, and a second slave terminal apparatus 40.

The base station 10 provides a communication network based on a prescribed radio communication scheme. The prescribed radio communication scheme may be a communication scheme using a fifth generation mobile communication system (5G system). For example, the prescribed radio communication scheme may be the local 5G. In the local 5G, a 5G system is installed not by nationwide mobile carriers but by a cable provider or the like in a limited range to perform data communication by radio. However, the prescribed radio communication scheme is not limited to the local 5G, and may be other radio communication schemes including, for example, a private Long Term Evolution (LTE) or a private 5G. The private LTE may include regional Broadband Wireless Access (BWA) or sXGP, for example. In the present embodiment, a description is given below assuming that the base station 10 provides a communication network based on the local 5G. Security of the communication network based on the local 5G can be improved by avoiding a communicative connection to an external network in utilization of the communication network based on the local 5G.

The terminal apparatus 20 is a terminal apparatus capable of data communication with the base station 10. The terminal apparatus 20 performs data communication with the base station 10 by using a communication network provided by the base station 10. The terminal apparatus 20 may be, for example, a router terminal, a smartphone, a tablet terminal, or the like.

Although only one terminal apparatus 20 is illustrated in FIG. 1, the communication system 1 may actually include multiple terminal apparatuses 20. The base station 10 is capable of performing data communication with the multiple terminal apparatuses 20 in a communicable area A1 of the communication network.

In the present embodiment, since the base station 10 provides a communication network based on the local 5G, the terminal apparatus 20 into which a Subscriber Identity Module (SIM) card registered on the base station 10 is inserted in advance only can perform data communication with the base station 10. Therefore, information of the SIM card that enables the terminal apparatus 20 to be capable of data communication with the base station 10 in a case that the SIM card is inserted into the terminal apparatus 20 is stored in, for example, a base station storage unit 12 described below to be registered on the base station 10 in advance. The base station 10 can limit a terminal apparatus for performing data communication to only the terminal apparatus 20 into which the registered SIM card is inserted in any known manner. For example, by performing authentication, the base station 10 performs data communication with the terminal apparatus 20 into which the registered SIM card is inserted. The base station 10 performs data communication only with the terminal apparatus 20 into which the SIM card registered on the base station 10 is inserted, thereby preventing information communication from being performed with an external terminal apparatus into which the SIM card registered on the base station 10 is not inserted. This ensures security in the communication network.

The terminal apparatus 20 has a tethering function. The tethering function is a function of operating as a master terminal apparatus that connects a slave terminal apparatus to the base station 10. In other words, the terminal apparatus 20 can operate as a master terminal apparatus in the tethering function. The terminal apparatus 20, in a case of operating as the master terminal apparatus, functions as an access point for the slave terminal apparatus. The terminal apparatus 20 can establish communication with the slave terminal apparatus using the tethering function by any known connection scheme. In the present embodiment, a description is given below assuming that the terminal apparatus 20 establishes communication with the slave terminal apparatus using the tethering function by a Wifi (trade name) connection. However, the terminal apparatus 20 may establish communication with the slave terminal apparatus using the tethering function by a Bluetooth (trade name) connection or a Universal Serial Bus (USB) connection.

A first slave terminal apparatus 30 and a second slave terminal apparatus 40 are terminal apparatuses capable of utilizing a communicative connection using the tethering function of the terminal apparatus 20. In other words, the first slave terminal apparatus 30 and the second slave terminal apparatus 40 are slave terminal apparatuses capable of communicative connection to the terminal apparatus 20 using the tethering function. Each of the first slave terminal apparatus 30 and the second slave terminal apparatus 40 may be, for example, a computer, a smartphone, a tablet terminal, or the like.

The first slave terminal apparatus 30 is a slave terminal apparatus for which a communicative connection to the communication network provided by the base station 10 is allowed. For example, the first slave terminal apparatus 30 is registered on the base station 10 in advance. On the other hand, the second slave terminal apparatus 40 is a slave terminal apparatus for which a communicative connection to the communication network provided by the base station 10 is not allowed. Therefore, for example, the second slave terminal apparatus 40 is not registered on the base station 10. In the following, a communicative connection to the base station 10 being allowed is also simply expressed herein as “connection-allowed”. In other words, in the present embodiment, the first slave terminal apparatus 30 is allowed to connect to the base station 10, and the second slave terminal apparatus 40 is not allowed to connect to the base station 10.

Although FIG. 1 illustrates only one first slave terminal apparatus 30 and one second slave terminal apparatus 40, actually, the communication system 1 may include multiple first slave terminal apparatuses 30 and multiple second slave terminal apparatuses 40. In other words, the terminal apparatus 20 can perform communication using the tethering function with the multiple first slave terminal apparatuses 30 and the multiple second slave terminal apparatuses 40 in an area A2 in which the communication using the tethering function is possible.

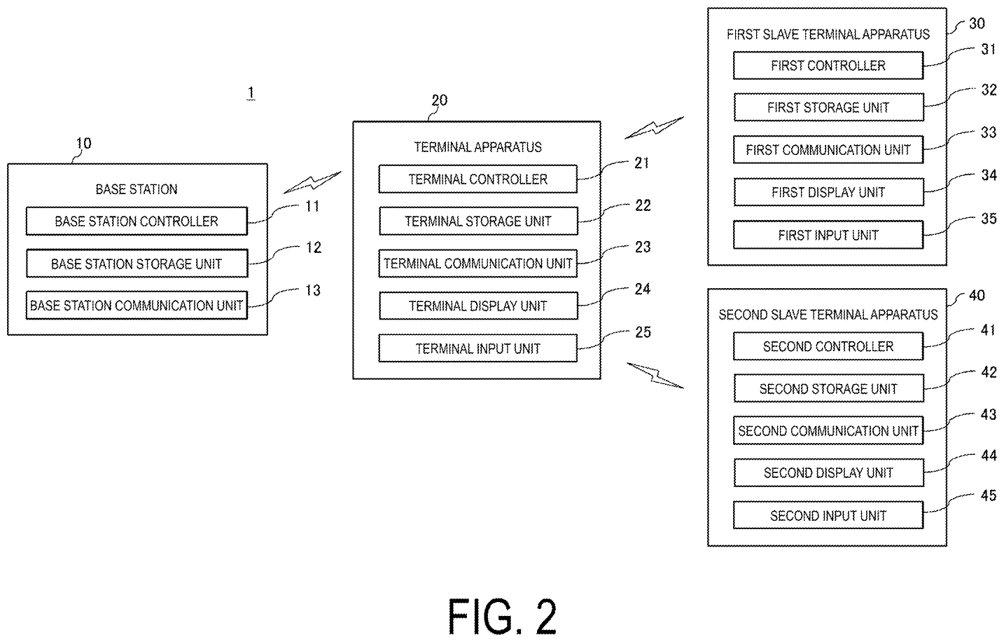

FIG. 2 is a function block diagram illustrating an example of configuration of the communication system 1 of FIG. 1.

As illustrated in FIG. 2, the base station 10 includes a base station controller 11, a base station storage unit 12, and a base station communication unit 13 as functional units.

The base station controller 11 controls and manages the entire base station 10 including the respective functional units of the base station 10. The base station controller 11 includes at least one processor. The base station controller 11 includes a processor such as a Central Processing Unit (CPU) that executes a program defining a control procedure or a dedicated processor specialized in processing of each function. Note that the base station controller 11 may be included in, instead of the base station 10, a cloud capable of communicative connection to the base station 10, for example.

For example, the base station controller 11 controls data communication between the base station 10 and the terminal apparatus 20 into which the SIM card registered on the base station 10 is inserted. In other words, the base station controller 11 determines whether the terminal apparatus 20 attempting to perform data communication is a terminal apparatus into which a SIM card registered on the base station 10 is inserted, and performs data communication with the terminal apparatus 20 in a case of determining that the terminal apparatus 20 is the terminal apparatus into which the SIM card registered on the base station 10 is inserted. The information related to the SIM card is stored in advance in the base station storage unit 12, for example. In a case that the base station controller 11 receives, from the terminal apparatus 20 attempting to perform data communication, information related to the terminal apparatus, the base station controller 11 refers to the information related to the terminal apparatus stored in the base station storage unit 12 and determines whether the SIM card registered on the base station 10 is inserted into the terminal apparatus 20. In a case that the base station controller 11 determines that the SIM card registered on the base station 10 is inserted into the terminal apparatus 20, the base station controller 11 performs data communication with the terminal apparatus 20.

In the present embodiment, in a case of attempting to establish the communicative connection between the slave terminal apparatus and the base station 10 via the terminal apparatus 20 using the tethering function, the base station controller 11 determines whether the communicative connection by the slave terminal apparatus to the base station 10 is allowed. In other words, in a case that the terminal apparatus 20 performing data communication with the base station 10 performs communication with the slave terminal apparatus using the tethering function, the base station controller 11 determines whether a communication connective by the slave terminal apparatus to the communication network provided by the base station 10 is allowed. The base station controller 11 performs processing according to the determination result. Details of the processing performed by the base station controller 11 is described below.

The base station storage unit 12 is a storage medium capable of storing programs and data. The base station storage unit 12 can include, for example, a semiconductor memory, a magnetic memory, or the like. The base station storage unit 12 may store, for example, a program for causing the base station 10 to operate. Similar to the base station controller 11, the base station storage unit 12 may also be included in, instead of the base station 10, a cloud capable of communicative connection to the base station 10, for example.

The base station storage unit 12 stores, for example, information related to a terminal apparatus for which a data communicative connection to the base station 10 is allowed (hereinafter, also referred to as “terminal information”). The terminal information is information capable of uniquely identifying a terminal apparatus. The terminal information may be any information including, for example, an International Mobile Equipment Identity (IMEI) number or a serial number. The base station storage unit 12 stores, for example, a list of the terminal information related to the terminal apparatuses for which a data communicative connection to the base station 10 are allowed.

In the present embodiment, the base station storage unit 12 stores, for example, information related to the slave terminal apparatus for which a communicative connection to the communication network provided by the base station 10 is allowed. The information related to the slave terminal apparatus (hereinafter also referred to as “slave terminal information”) is information capable of uniquely identifying the slave terminal apparatus. The slave terminal information may be any information including, for example, an IMEI number or a serial number. The base station storage unit 12 stores, for example, a list of the slave terminal information related to the slave terminal apparatus for which a communicative connection to the communication network provided by the base station 10 is allowed.

The base station communication unit 13 transmits and/or receives data (radio signal) through radio communication via an antenna. The radio signal is used for data communication with the terminal apparatus 20. Data communication between the base station 10 and the terminal apparatus 20 is performed by the transmission and/or reception of the data. The data received by the base station communication unit 13 is subjected to prescribed processing by the base station controller 11. The prescribed processing is known processing including, for example, AD conversion and Fourier transform. The base station communication unit 13 transmits a radio signal generated by the base station controller 11 from the antenna.

As illustrated in FIG. 2, the terminal apparatus 20 includes a terminal controller 21, a terminal storage unit 22, a terminal communication unit 23, a terminal display unit 24, and a terminal input unit 25 as functional units.

The terminal controller 21 controls and manages the entire terminal apparatus 20 including the respective functional units of the terminal apparatus 20. The terminal controller 21 includes at least one processor. The terminal controller 21 includes a processor such as a CPU that executes a program defining a control procedure or a dedicated processor specialized in processing of each function.

In a case that the terminal apparatus 20 performs communication with the slave terminal apparatus using the tethering function, the terminal controller 21 controls processing of the communication using the tethering function. In a case that the terminal apparatus 20 performs communication with the slave terminal apparatus using the tethering function, and that the base station controller 11 determines that the slave terminal apparatus is the connection-not-allowed second slave terminal apparatus 40, the terminal controller 21 may perform processing based on the determination result. Details of the processing performed by the terminal controller 21 is described below.

The terminal storage unit 22 is a storage medium capable of storing programs and data. The terminal storage unit 22 can include, for example, a semiconductor memory, a magnetic memory, or the like. The terminal storage unit 22 may store, for example, a program for causing the terminal apparatus 20 to operate. The terminal storage unit 22 may store the terminal information of the terminal apparatus 20 including the terminal storage unit 22. For example, the terminal storage unit 22 may store an IMEI number, a serial number, or the like.

The terminal communication unit 23 transmits and/or receives data through radio communication via an antenna. Data communication between the base station 10 and the terminal apparatus 20 is performed by the transmission and/or reception of the data. The data received by the terminal communication unit 23 is subjected to prescribed processing by the terminal controller 21. The prescribed processing is known processing including, for example, AD conversion and Fourier transform. The terminal communication unit 23 transmits a radio signal generated by the terminal controller 21 from the antenna. In a case that the terminal apparatus 20 establishes a communicative connection to the slave terminal apparatus using the tethering function, the terminal apparatus 20 originates, for example, a Wifi signal for the communicative connection using the tethering function (hereinafter also referred to as “tethering connection”). Note that in a case that communication using the tethering function is established by a USB connection, the terminal communication unit 23 may transmit and/or receive data by wired communication via a USB cable.

The terminal display unit 24 includes a display device such as a Liquid Crystal Display, an organic EL panel (Organic Electro-Luminescence Panel), or an inorganic EL panel (Inorganic Electro-Luminescence panel). The terminal display unit 24 displays characters, images, symbols, figures, or the like. The terminal display unit 24 may include a touch screen display having not only a display function but also a touch screen function. In this case, a touch screen detects contact of a finger of a user of the terminal apparatus 20, a stylus pen, or the like.

The terminal input unit 25 accepts an operation input from the user of the terminal apparatus 20. The terminal input unit 25 includes, for example, an operation button (operation key). The terminal input unit 25 may include a touch screen, and an input region for accepting an operation input from the user may be displayed on a part of the display device which is the terminal display unit 24 to accept a touch operation input from the user.

As illustrated in FIG. 2, the first slave terminal apparatus 30 includes a first controller 31, a first storage unit 32, a first communication unit 33, a first display unit 34, and a first input unit 35 as functional units.

The first controller 31 controls and manages the entire first slave terminal apparatus 30 including the respective functional units of the first slave terminal apparatus 30. The first controller 31 includes at least one processor. The first controller 31 includes a processor such as a CPU that executes a program defining a control procedure or a dedicated processor specialized in processing of each function. The first controller 31 controls processing of the communication using the tethering function, for example.

The first storage unit 32 is a storage medium capable of storing programs and data. The first storage unit 32 can include, for example, a semiconductor memory, a magnetic memory, or the like. The first storage unit 32 may store, for example, a program for causing the first slave terminal apparatus 30 to operate. The first storage unit 32 may store the slave terminal information of the first slave terminal apparatus 30 including the first storage unit 32. For example, the first storage unit 32 may store an IMEI number, a serial number, or the like.

The first communication unit 33 transmits and/or receives data through radio communication via an antenna. In the present embodiment, the first communication unit 33 transmits and/or receives data through radio communication using at least the tethering function. Note that in a case that communication using the tethering function is established by a USB connection, the first communication unit 33 may transmit and/or receive data by wired communication via a USB cable. The data received by the first communication unit 33 is subjected to prescribed processing by the first controller 31. The prescribed processing is known processing including, for example, AD conversion and Fourier transform.

The first display unit 34 includes a display device such as a liquid crystal display, an organic EL panel, or an inorganic EL panel. The first display unit 34 displays characters, images, symbols, figures, or the like. The first display unit 34 may include a touch screen display having not only a display function but also a touch screen function. In this case, a touch screen detects contact of a finger of a user of the first slave terminal apparatus 30, a stylus pen, or the like.

The first input unit 35 accepts an operation input from the user of the first slave terminal apparatus 30. The first input unit 35 includes, for example, an operation button (operation key). The first input unit 35 may include a touch screen, and an input region for accepting an operation input from the user may be displayed on a part of the display device which is the first display unit 34 to accept a touch operation input from the user.

As illustrated in FIG. 2, the second slave terminal apparatus 40 includes a second controller 41, a second storage unit 42, a second communication unit 43, a second display unit 44, and a second input unit 45 as functional units. The configurations and functions of the second controller 41, the second storage unit 42, the second communication unit 43, the second display unit 44, and the second input unit 45 included in the second slave terminal apparatus 40 may be the same as those of the first controller 31, the first storage unit 32, the first communication unit 33, the first display unit 34, and the first input unit 35 included in the first slave terminal apparatus 30, respectively. Therefore, detailed descriptions of the second controller 41, the second storage unit 42, the second communication unit 43, the second display unit 44, and the second input unit 45 are omitted here.

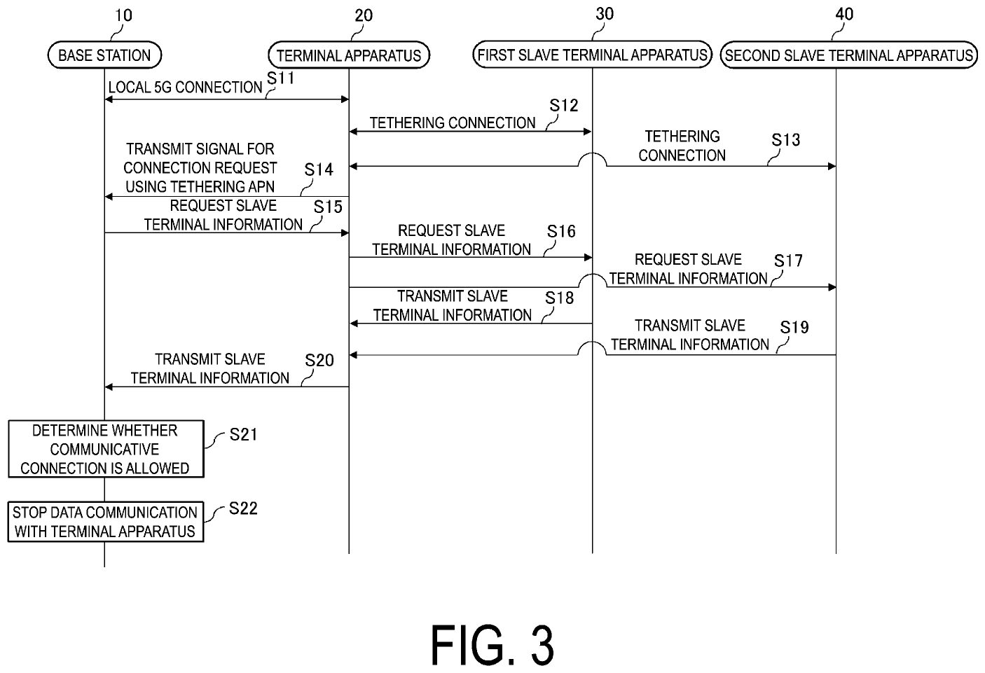

Next, an example of processing performed by the communication system 1 is described. FIG. 3 is a sequence diagram illustrating a first example of processing by the communication system 1 of FIG. 2, the sequence diagram also illustrating an example of a communication control method according to the disclosure.

First, the base station 10 establishes a communicative connection to the terminal apparatus 20 over the communication network. In the present embodiment, the base station 10 establishes a local 5G connection to the terminal apparatus 20 (step S11). For example, the base station 10 authenticates a SIM card inserted into the terminal apparatus 20 and confirms that the SIM card inserted into the terminal apparatus 20 is a SIM card registered on the base station 10, thereby establishing a communicative connection to the terminal apparatus 20.

In a case that the user of the terminal apparatus 20 performs a prescribed input operation to the terminal apparatus 20 for causing the terminal apparatus 20 to perform the tethering function, the terminal apparatus 20 performs the tethering function. For example, the terminal apparatus 20 originates a Wifi signal for tethering connection. The first slave terminal apparatus 30 receives, for example, the Wifi signal originated from the terminal apparatus 20 and establishes a tethering connection to the terminal apparatus 20 (step S12). Similarly, the second slave terminal apparatus 40 receives, for example, the Wifi signal originated from the terminal apparatus 20 and establishes a tethering connection to the terminal apparatus 20 (step S13).

In a case that the terminal apparatus 20 detects that the tethering connection is established with at least one slave terminal apparatus, the terminal apparatus 20 transmits a signal for a connection request using a tethering APN (step S14). The tethering APN is an access point name used in the case that the terminal apparatus 20 performs the tethering function. In other words, in step S14, the terminal apparatus 20 transmits to the base station 10 a signal for requesting to establish a communicative connection using the access point name for performing the tethering function.

The base station 10 receives the signal for the connection request using the tethering APN from the terminal apparatus 20, and thereby can recognize that the terminal apparatus 20 is performing the tethering function.

In a case that the base station 10 receives the signal for the connection request using the tethering APN from the terminal apparatus 20, the base station 10 determines whether the slave terminal apparatus attempting to establish the communicative connection to the base station 10 using the tethering function is a connection-allowed slave terminal apparatus. The slave terminal apparatus attempting to establish a communicative connection to the base station 10 using the tethering function is a slave terminal apparatus which has establishes the tethering connection to the terminal apparatus 20, and in this example, includes the first slave terminal apparatus 30 and the second slave terminal apparatus 40.

Specifically, the base station 10 determines whether the communicative connection by the slave terminal apparatus to the base station 10 is allowed based on whether the slave terminal information of the slave terminal apparatus capable of utilizing the communicative connection using the tethering function is included in the slave terminal information stored in the base station storage unit 12. To be more specific, the base station 10 determines whether the communicative connection by the slave terminal apparatus to the base station 10 is allowed, in steps S15, S20, and S21, for example.

In other words, the base station 10, in the case of receiving the signal for the connection request using the tethering APN from the terminal apparatus 20, transmits a signal for requesting the slave terminal information to the terminal apparatus 20 (step S15). Specifically, the base station 10 transmits a signal for requesting the slave terminal information of the slave terminal apparatus with which the terminal apparatus 20 establishes the communicative connection using the tethering function. Here, the slave terminal apparatus with which the terminal apparatus 20 establishes the communicative connection using the tethering function includes the first slave terminal apparatus 30 and the second slave terminal apparatus 40 with which the tethering connections are established in step S12 and step S13, respectively.

The terminal apparatus 20, in a case of receiving the signal for requesting the slave terminal information from the base station 10, transmits the signal for requesting the slave terminal information to all the slave terminal apparatuses which have established the tethering connections with the terminal apparatus 20. In other words, in this example, the terminal apparatus 20 transmits the signal for requesting the slave terminal information to the first slave terminal apparatus 30 (step S16). Similarly, the terminal apparatus 20 transmits the signal for requesting the slave terminal information to the second slave terminal apparatus 40 (step S17). In steps S16 and S17, the terminal apparatus 20 may transmit (transfer) the signal for requesting the slave terminal information received in step S15 without change to the first slave terminal apparatus 30 and the second slave terminal apparatus 40, or may generate a new signal based on the signal for requesting the slave terminal information received in step S15 and transmit the new signal to the first slave terminal apparatus 30 and the second slave terminal apparatus 40.

The first slave terminal apparatus 30, in response to receiving the signal for requesting the slave terminal information from the terminal apparatus 20, transmits the slave terminal information of the first slave terminal apparatus 30 stored in the first storage unit 32 to the terminal apparatus 20 (step S18). Similarly, the second slave terminal apparatus 40, in response to receiving the signal for requesting the slave terminal information from the terminal apparatus 20, transmits the slave terminal information of the second slave terminal apparatus 40 stored in the second storage unit 42 to the terminal apparatus 20 (step S19).

The terminal apparatus 20 transmits the slave terminal information received from the slave terminal apparatus to the base station 10 (step S20). In other words, in this example, the terminal apparatus 20 transmits the slave terminal information of the first slave terminal apparatus 30 and the second slave terminal apparatus 40 to the base station 10.

The base station 10, in a case of receiving the slave terminal information from the terminal apparatus 20, determines whether communicative connection by the slave terminal apparatus having the slave terminal information to the base station 10 is allowed. (step S21). The base station 10 determines whether the communicative connection to the base station 10 is allowed, for example, by determining whether the slave terminal information received from the terminal apparatus 20 is stored in the base station storage unit 12. In other words, the base station 10 determines whether the slave terminal information received from the terminal apparatus 20 is included in the list, stored in the base station storage unit 12, of slave terminal information related to the connection-allowed slave terminal apparatus. In a case that the slave terminal information received from the terminal apparatus 20 is included in the list, the base station 10 determines that the slave terminal apparatus of the slave terminal information is allowed to communicatively connect with the base station 10. On the other hand, in a case that the slave terminal information received from the terminal apparatus 20 is not included in the list, the base station 10 determines that the communicative connection by the slave terminal apparatus of the slave terminal information with the base station 10 is not allowed.

The base station 10, in a case of receiving multiple pieces of slave terminal information from the terminal apparatus 20, determines whether a communicative connection is allowed for multiple slave terminal apparatuses respectively corresponding to the multiple pieces of slave terminal information in step S21. In other words, in this case, the base station 10 determines whether each of the multiple pieces of slave terminal information is included in the list, stored in the base station storage unit 12, of the slave terminal information related to the slave terminal apparatus for which a communicative connection is allowed. In the present embodiment, since the base station 10 receives the slave terminal information of the first slave terminal apparatus 30 and the second slave terminal apparatus 40, the base station 10 determines in step S21 whether a communicative connection is allowed for these two slave terminal apparatuses.

In this example, the slave terminal information of the first slave terminal apparatus 30 is included in the list stored in the base station storage unit 12. Therefore, the base station 10 determines that a communicative connection by the first slave terminal apparatus 30 with the base station 10 is allowed. On the other hand, the slave terminal information of the second slave terminal apparatus 40 is not included in the list stored in the base station storage unit 12. Therefore, the base station 10 determines that a communicative connection by the second slave terminal apparatus 40 with the base station 10 is not allowed.

In step S21, in a case that the base station 10 determines that a communicative connection by the slave terminal apparatus to the base station 10 is not allowed, at least the communicative connection between the slave terminal apparatus and the base station 10 is stopped in the communication system 1. In this case, for example, the base station 10 performs control to stop at least the communicative connection between the slave terminal apparatus and the base station 10. In this example, since it is determined that a communicative connection between the second slave terminal apparatus 40 and the base station 10 is not allowed, the base station 10 performs control to stop at least the communicative connection between the second slave terminal apparatus 40 and the base station 10.

In the first example illustrated in FIG. 3, as the control to stop at least the communicative connection between the second slave terminal apparatus 40 and the base station 10, the base station 10 stops the data communication with the terminal apparatus 20 (step S22). As a result, the terminal apparatus 20 cannot perform data communication with the base station 10, and therefore cannot perform communication between the slave terminal apparatus and the base station using the tethering function. Therefore, the communicative connection between the second slave terminal apparatus 40 and the base station 10 is stopped.

In this case, since the data communication between the base station 10 and the terminal apparatus 20 is stopped, the first slave terminal apparatus 30 for which a communicative connection is allowed also cannot perform the communicative connection to the base station 10 using the tethering function. However, as described in the first example, the base station 10 may stop the data communication with the terminal apparatus 20 in order to prevent the second slave terminal apparatus 40, for which a communicative connection is not allowed, from establishing a communicative connection to the base station 10 in an unauthorized manner.

Note that in a case that the base station 10 determines in step S21 that a communicative connection is allowed for all of the multiple slave terminal apparatuses respectively corresponding to the received pieces of slave terminal information, the base station 10 allows the connection request using the tethering APN by the terminal apparatus 20 and causes the terminal apparatus 20 to establish a communicative connection using the tethering function. By doing so, the slave terminal apparatus can perform a communicative connection to the base station 10 via the terminal apparatus 20 functioning as the master terminal apparatus.

The first example of the processing illustrated in FIG. 3 describes that the base station 10 stops the data communication with the terminal apparatus 20 as the control to stop at least the communicative connection between the second slave terminal apparatus 40 and the base station 10. However, the control to stop at least the communicative connection between the second slave terminal apparatus 40 and the base station 10 is not limited to this. Second and third examples of the processing are described as other examples of the control to stop at least the communicative connection between the second slave terminal apparatus 40 and the base station 10.

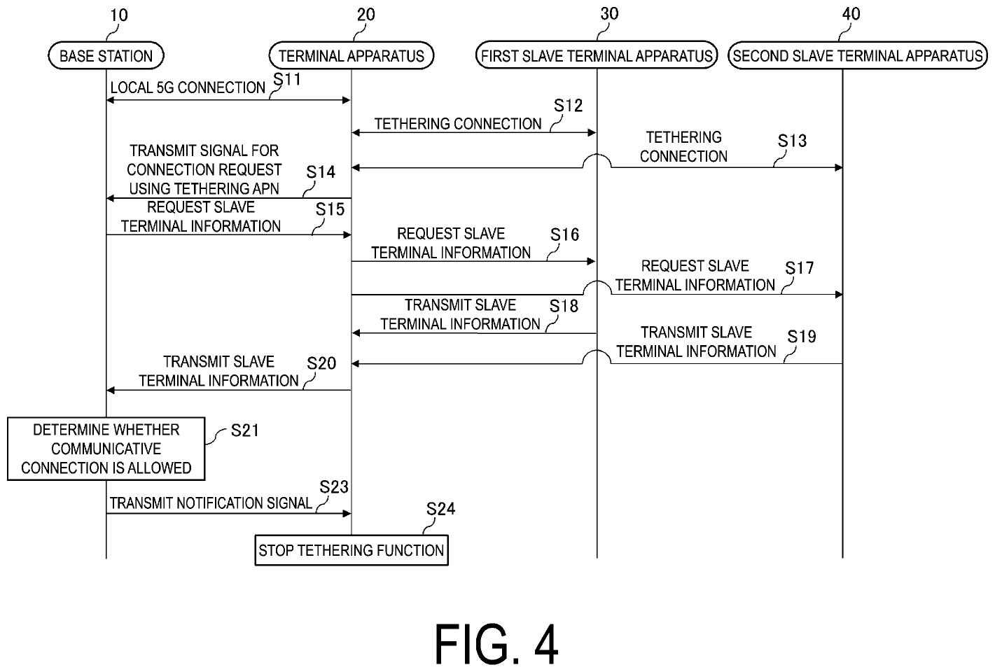

FIG. 4 is a sequence diagram illustrating the second example of the processing by the communication system 1 of FIG. 2. In the processing of the second example illustrated in FIG. 4, steps S11 to S21 are the same as steps S11 to S21 of the first example described with reference to FIG. 3, respectively, and therefore detailed description thereof is omitted here.

The base station 10, in the case of determining in step S21 that a communicative connection by the slave terminal apparatus to the base station 10 is not allowed, performs control to stop at least the communicative connection between the slave terminal apparatus and the base station 10. In the second example illustrated in FIG. 4, as the control to stop at least the communicative connection between the second slave terminal apparatus 40 and the base station 10, the base station 10 transmits to the terminal apparatus 20 a signal signaling that a communicative connection is not allowed for the slave terminal apparatus (hereinafter also referred to as a “notification signal”) (step S23). The base station 10 may include, in the notification signal, the slave terminal information of the slave terminal apparatus for which it is determined that a communicative connection is not allowed, and transmit the notification signal to the terminal apparatus 20. In this example, the base station 10 includes, in the notification signal, the slave terminal information of the second slave terminal apparatus 40 for which a communicative connection is not allowed and transmits the notification signal to the terminal apparatus 20.

In a case that the terminal apparatus 20 receives the notification signal from the base station 10, the terminal apparatus 20 stops the tethering function (step S24). For example, the terminal apparatus 20 may stop originating the Wifi signal for the tethering connection. For example, the terminal apparatus 20 may disable the data communication with the base station 10 using the tethering function. For example, the terminal apparatus 20 may perform control to not authenticate the data communicated using the tethering function. The terminal apparatus 20 may stop the tethering function by a method other than the method described here. The terminal apparatus 20 stopping the tethering function causes the communicative connection between the second slave terminal apparatus 40 and the base station 10 to stop.

In this case, since the tethering function of the terminal apparatus 20 itself is stopped, the first slave terminal apparatus 30 for which a communicative connection is allowed also cannot perform the communicative connection to the base station 10 using the tethering function. However, as described in the second example, the terminal apparatus 20 may stop the tethering function in order to prevent the second slave terminal apparatus 40, for which a communicative connection is not allowed, from establishing a communicative connection to the base station 10 in an unauthorized manner.

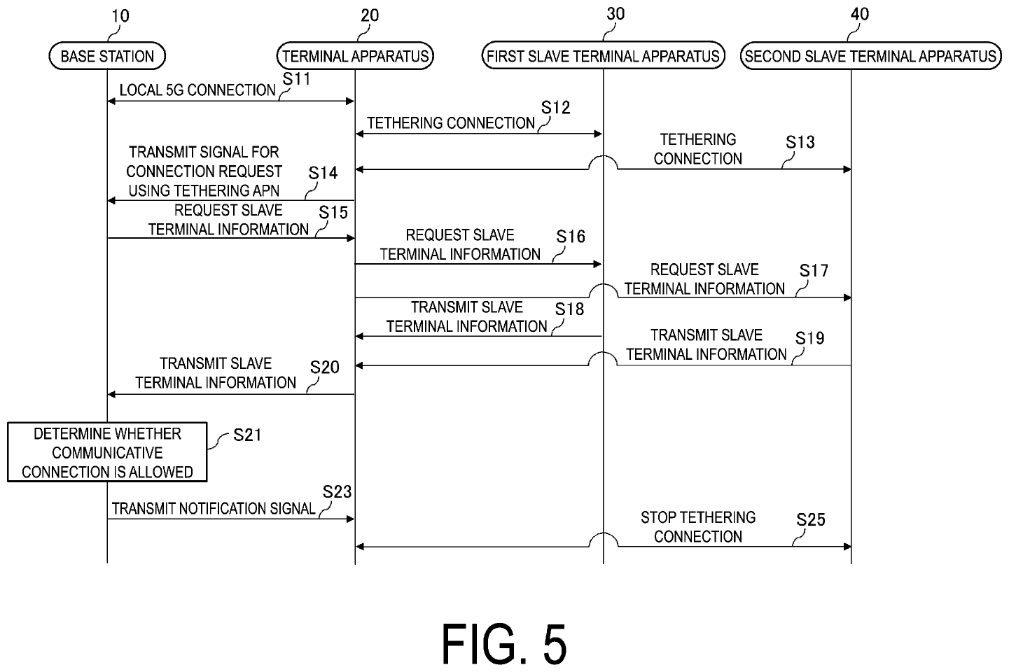

FIG. 5 is a sequence diagram illustrating the third example of the processing by the communication system 1 of FIG. 2. In the processing of the third example illustrated in FIG. 5, steps S11 to S21 are the same as steps S11 to S21 of the first example described with reference to FIG. 3, respectively, and therefore detailed description thereof is omitted here.

The base station 10, in the case of determining in step S21 that a communicative connection by the slave terminal apparatus to the base station 10 is not allowed, performs control to stop at least the communicative connection between the slave terminal apparatus and the base station 10. In the third example illustrated in FIG. 5, as the control to stop at least the communicative connection between the second slave terminal apparatus 40 and the base station 10, the notification signal is transmitted to the terminal apparatus 20 (step S23). Step S23 in the processing of the third example may be the same as step S23 in the processing of the second example.

In the case that the terminal apparatus 20 receives the notification signal from the base station 10, the terminal apparatus 20 stops the communicative connection using the tethering function with the slave terminal apparatus for which a communicative connection is not allowed (step S25). Specifically, the terminal apparatus 20 specifies the slave terminal apparatus for which it is determined that a communicative connection is not allowed, based on the slave terminal information, included in the communication signal, of the slave terminal apparatus for which it is determined that the communicative connection is not allowed. In this example, the second slave terminal apparatus 40 is specified as a slave terminal apparatus for which it is determined that a communicative connection is not allowed. The terminal apparatus 20 stops the tethering connection to the specified second slave terminal apparatus 40. For example, the terminal apparatus 20 may perform control to not assign an IP address to the slave terminal apparatus (here, the second slave terminal apparatus 40) indicated by the slave terminal information included in the notification signal. For example, the terminal apparatus 20 may perform control to not authenticate the data received from the second slave terminal apparatus 40. The terminal apparatus 20 may stop the tethering connection to the second slave terminal apparatus 40 by a method other than the method described here. The terminal apparatus 20 stopping the tethering function with the second slave terminal apparatus 40 causes the communicative connection between the second slave terminal apparatus 40 and the base station 10 to stop.

In the case of the third example, the terminal apparatus 20 stops the tethering connection to the second slave terminal apparatus 40. Therefore, the tethering connection to the first slave terminal apparatus 30 is maintained. In other words, the first slave terminal apparatus 30 for which a communicative connection is allowed can establish a communicative connection to the base station 10 using the tethering function. In this way, the communication system 1 can perform the tethering connection by the first slave terminal apparatus 30 for which a communicative connection is allowed while stopping the communicative connection to the second slave terminal apparatus 40 for which a communicative connection is not allowed.

As described above in the first to third examples, the stopping of the communicative connection between the second slave terminal apparatus 40 and the base station 10 may be performed by either the base station 10 or the terminal apparatus 20. In other words, in the case that a communicative connection by the second slave terminal apparatus 40 with the base station 10 is not allowed, the base station 10 or the terminal apparatus 20 may stop at least the communicative connection between the second slave terminal apparatus 40 and the base station 10.

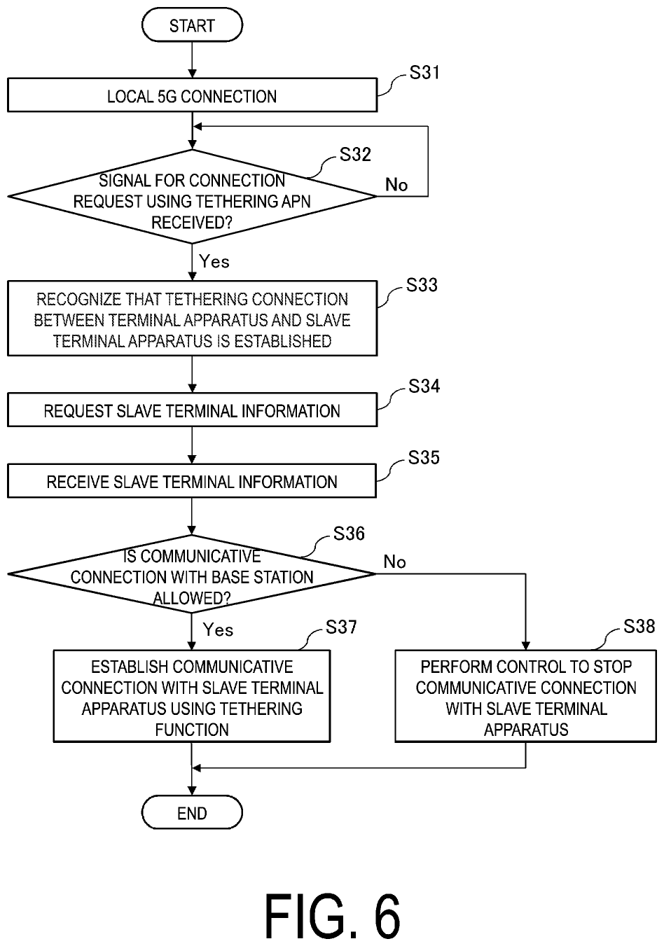

FIG. 6 is a flowchart illustrating an example of the processing performed by the base station 10 of FIG. 2.

First, the base station 10 establishes a local 5G connection to the terminal apparatus 20 (step S31). For example, as described with reference to step S11 of FIG. 3, the base station 10 authenticates a SIM card inserted into the terminal apparatus 20 and confirms that the SIM card inserted into the terminal apparatus 20 is a SIM card registered on the base station 10, thereby establishing a communicative connection to the terminal apparatus 20. The base station 10, after establishing the local 5G connection with the terminal apparatus 20, can perform data communication to the base station 10 using the communication network of the local 5G.

The base station 10 determines whether the base station 10 receives a signal of a connection request using a tethering APN from the terminal apparatus 20 (step S32). For example, as described in step S14 of FIG. 3, the terminal apparatus 20 can transmit the signal for the connection request using the tethering APN. In a case that the terminal apparatus 20 transmits the signal and the base station 10 receives the signal, the base station 10, in step S32, determines that the base station 10 receives the signal of the connection request using the tethering APN.

In a case that the base station 10 determines that the base station 10 does not receive the signal of the connection request using the tethering APN (No in step S32), the base station 10 repeats step S32 until it is determined that the signal of the connection request using the tethering APN is received.

The base station, in the case of determining that the base station 10 receives the signal of the connection request using the tethering APN (Yes in step S32), can recognize that the tethering connection is established between the terminal apparatus 20 and the slave terminal apparatus (step S33).

In this case, the base station 10 transmits a signal for requesting the slave terminal information to the terminal apparatus 20 (step S34). The signal transmitted in step S34 is the same as the signal described in step S15 of FIG. 3.

As described in steps S16 to S20 of FIG. 3, the terminal apparatus 20 in the case of receiving the signal for requesting the slave terminal information from the base station 10 acquires the slave terminal information from the slave terminal apparatus which has established the tethering connection, and transmits the acquired slave terminal information to the base station 10.

The base station 10 receives the slave terminal information transmitted from the terminal apparatus 20 (step S35).

Then, based on the received slave terminal information, the base station 10 determines whether a communicative connection by the slave terminal apparatus having the slave terminal information with the base station 10 is allowed (step S36). Details of the processing performed by the base station 10 in step S36 may be the same as the processing described in step S21 of FIG. 3. In other words, for example, the base station 10 may refer to the list stored in the base station storage unit 12 to determine whether the communicative connection by the slave terminal apparatus to the base station 10 is allowed.

In a case that the base station 10 determines that a communicative connection by the slave terminal apparatus to the base station 10 is allowed (Yes in step S36), the base station 10 establishes a communicative connection to the slave terminal apparatus using the tethering function (step S37). Thus, the communicative connection between the base station 10 and the slave terminal apparatus is performed via the terminal apparatus 20 functioning as the master terminal apparatus.

On the other hand, the base station 10, in a case of determining that a communicative connection by the slave terminal apparatus to the base station 10 is not allowed (No in step S36), performs control to stop at least the communicative connection between the slave terminal apparatus and the base station 10 (step S38). The base station 10 can perform the control to stop the communicative connection between the slave terminal apparatus and the base station 10 by various methods. For example, as described in step S22 of FIG. 3, the base station 10 can stop the communicative connection between the slave terminal apparatus and the base station 10 by stopping the data communication with the terminal apparatus 20. For example, as described in step S23 of FIGS. 4 and 5, the base station 10 may transmit the notification signal to the terminal apparatus 20. In this case, the terminal apparatus 20 receiving the notification signal stops the tethering function, for example as described in step S24 of FIG. 4, or stops the tethering connection to the slave terminal apparatus for which a communicative connection is not allowed as described in step S25 of FIG. 5, thereby stopping the communicative connection between the slave terminal apparatus and the base station 10.

In the communication system 1 of the present embodiment, in the case that a communicative connection by the slave terminal apparatus to the base station 10 is not allowed, at least the communicative connection between the slave terminal apparatus and the base station 10 is stopped. In the example described in the present embodiment, since a communicative connection by the second slave terminal apparatus 40 with the base station 10 is not allowed, at least the communicative connection between the second slave terminal apparatus 40 and the base station 10 is stopped. This can prevent the second slave terminal apparatus 40, for which a communicative connection to the base station 10 is not allowed, from communicatively connecting to the base station 10 via the terminal apparatus 20. Therefore, according to the communication system 1, security in communication using the tethering function can be improved.

The above embodiment describes that the base station storage unit 12 of the base station 10 stores the slave terminal information of the connection-allowed slave terminal apparatus and determines whether a communicative connection by the slave terminal apparatus to the base station 10 is allowed. However, the determination may not necessarily be performed by the base station 10. The determination may be performed by the terminal apparatus 20, for example. In this case, the terminal storage unit 22 of the terminal apparatus 20 stores the slave terminal information of the connection-allowed slave terminal apparatus. For example, the terminal apparatus 20 may determine whether the slave terminal information of the slave terminal apparatus is included in the slave terminal information stored in the terminal storage unit 22 in a case that the tethering connection is established with the slave terminal apparatus, thereby determining whether a communicative connection by the slave terminal apparatus to the base station 10 is allowed. Therefore, the determination on whether a communicative connection by the slave terminal apparatus to the base station 10 is allowed may be performed by at least one of the base station 10 and the terminal apparatus 20.

The above embodiment describes the example in which a tethering connection is established by a Wifi connection. However, the communication system 1 according to the disclosure can also be applied to a case that a tethering connection is established by other connection methods. For example, even in a case that a tethering connection is established by a USB connection via a USB cable or a tethering connection is established by a Bluetooth connection, the communicative connection between the slave terminal apparatus and the base station 10 may be stopped in the case that a communicative connection between the slave terminal apparatus and the base station 10 is not allowed.

The above embodiment describes that the base station 10 recognizes that the tethering connection is established between the terminal apparatus 20 and the slave terminal apparatus in the case that the base station 10 receives the signal for the connection request using the tethering APN from the terminal apparatus 20. However, the base station 10 may recognize that the tethering connection is established between the terminal apparatus 20 and the slave terminal apparatus by other methods. For example, the terminal apparatus 20 may transmit, to the base station 10, a notification signal signaling that the tethering connection is established between the terminal apparatus 20 and the slave terminal apparatus. In this case, by receiving the notification signal, the base station 10 can recognize that the tethering connection is established between the terminal apparatus 20 and the slave terminal apparatus. This method is effective, for example, in a case that the APN used for the terminal apparatus 20 performing terminal communication without using the tethering function is the same as the APN used for the terminal apparatus 20 performing tethering communication using the tethering function. The base station 10 may recognize that the tethering connection is established between the terminal apparatus 20 and the slave terminal apparatus based on a data format of the data received from the terminal apparatus 20.

The above embodiment describes the case that after the local 5G connection is established between the base station 10 and the terminal apparatus 20 (step S11), the tethering connection is established between the terminal apparatus 20 and each of the first slave terminal apparatus 30 and the second slave terminal apparatus 40 (steps S12 and S13). However, the tethering connection may be established between the terminal apparatus 20 and each of the first slave terminal apparatus 30 and the second slave terminal apparatus 40, before the local 5G connection is established between the base station 10 and the terminal apparatus 20. In this case, after the local 5G connection is established between the base station 10 and the terminal apparatus 20, the base station 10 may transmit the signal for requesting the slave terminal information to the terminal apparatus 20.

The above embodiment describes that the base station 10 determines whether the communicative connection by the slave terminal apparatus to the base station 10 is allowed based on the slave terminal information of the slave terminal apparatus which attempts to communicatively connect to the base station 10 using the tethering function. The base station 10 may use a method similar to this to request the terminal information from the terminal apparatus 20 functioning as the master terminal apparatus, and determine whether the communicative connection by the terminal apparatus 20 with the base station 10 is allowed based on the terminal information. The base station 10, in a case of determining that a communicative connection by the terminal apparatus 20 with the base station 10 is not allowed, may stop the data communication between the base station 10 and the connection-not-allowed terminal apparatus 20. This can prevent, for example, a SIM card for which a communicative communication is allowed based on the local 5G provided by the base station 10 from being inserted and used in a terminal apparatus for which a communicative connection to the base station 10 is not allowed.

Although the disclosure has been described based on the drawings and the embodiments, it should be noted that those skilled in the art can easily make various changes and modifications based on the disclosure. Therefore, it should be noted that these changes and modifications are included in the scope of the disclosure. For example, the function or the like included in each functional unit, each step, or the like can be rearranged so as not to be logically inconsistent, and multiple functional units, steps, or the like can be combined into one or divided.

1. A communication system comprising:
a base station;
a terminal apparatus configured to perform data communication with the base station, the terminal apparatus including a tethering function of operating as a master terminal apparatus configured to communicatively connect a slave terminal apparatus to the base station; and
the slave terminal apparatus configured to utilize the communicative connection using the tethering function included in the terminal apparatus,
wherein at least the communicative connection between the slave terminal apparatus and the base station is stopped, in a case that the communicative connection by the slave terminal apparatus to the base station is not allowed.

2. The communication system according to claim 1,
wherein the base station stops communication between the slave terminal apparatus and the base station by stopping the data communication with the terminal apparatus in the case that the communicative connection by the slave terminal apparatus to the base station is not allowed.

3. The communication system according to claim 1,
wherein the terminal apparatus stops the communicative connection between the slave terminal apparatus and the base station by stopping the tethering function in the case that the communicative connection by the slave terminal apparatus to the base station is not allowed.

4. The communication system according to claim 1,
wherein the terminal apparatus stops the communicative connection between the slave terminal apparatus and the base station by stopping the communicative connection to the slave terminal apparatus using the tethering function in the case that the communicative connection by the slave terminal apparatus to the base station is not allowed.

5. The communication system according to claim 1,
wherein at least one of the base station and the terminal apparatus
stores slave terminal information of the slave terminal apparatus for which the communicative connection with the base station is allowed, and
determines whether the communicative connection to the base station by the slave terminal apparatus configured to utilize the communicative connection using the tethering function is allowed, based on whether the stored slave terminal information includes slave terminal information of the slave terminal apparatus configured to utilize the communicative connection using the tethering function.

6. The communication system according to claim 1,
wherein the base station provides the data communication through local 5G, private Long Term Evolution (LTE), or private 5G.

7. A communication control method performed by a communication system, the communication system including
a base station,
a terminal apparatus configured to perform data communication with the base station, the terminal apparatus including a tethering function of operating as a master terminal apparatus configured to communicatively connect a slave terminal apparatus to the base station, and
the slave terminal apparatus configured to utilize the communicative connection using the tethering function included in the terminal apparatus,
the communication control method comprising
stopping, by the base station or the terminal apparatus, at least the communicative connection between the slave terminal apparatus and the base station, in a case that the communicative connection by the slave terminal apparatus to the base station is not allowed.

8. A base station comprising:
a communicator configured to transmit and/or receive a radio signal used for data communication with a terminal apparatus; and
a controller,
wherein the terminal apparatus includes a tethering function of operating as a master terminal apparatus configured to communicatively connect a slave terminal apparatus to the base station, and
the controller
determines whether the communicative connection by the slave terminal apparatus to the base station is allowed in a case of attempting to establish the communicative connection between the slave terminal apparatus and the base station via the terminal apparatus using the tethering function, and
performs control to stop at least the communicative connection between the slave terminal apparatus and the base station in the case that the communicative connection by the slave terminal apparatus to the base station is not allowed.
